(19) United States
(12) Patent Application Publication
(10) Pub. No.: US 2011/0106582 A1
(43) Pub. Date: May 5, 2011

(54) CONTACT EXPECTANCY AND NORMALIZATION

(75) Inventor: Jeanne Louise Jones, Omaha, NE (US)

(73) Assignee: ConAgra Foods RDM, Inc., Omaha, NE (US)

(21) Appl. No.: 12/611,303

(22) Filed: Nov. 3, 2009

(51) Int. Cl. G06Q 10/00; G06N 5/02; G06Q 50/00

(52) U.S. Cl. 705/7.29; 706/54

(57) ABSTRACT

Contact expectancy and normalization is described. A product can be normalized based on product complexity. The normalized product can be compared to a database of products having a similar product complexity to determine contact expectancy for the product. When a quantity of contacts is received, the quantity of contacts can be weighed based on the normalization of the product. The weighed quantity can then be compared to other weighed quantities of other products to facilitate an understanding of whether a product has an issue and/or achievement and to facilitate the allocation of quality control resources within an organization.

### BACKGROUND

Organizations often receive consumer contacts with regard to the products they produce. Contacts can take the form of a product inquiry, a product complaint and/or a product complement. Consumer contacts are typically measured by the quantity of contacts per quantity of units sold or shipped. A quality control division of the organization can then use the quantity of contacts for a product as an indicator of any potential product issues and/or achievement. However, utilizing the quantity of contacts associated with the product as an indicator of an issue and/or achievement of the product has several drawbacks for allocating quality control resources within an organization and for maintaining organizational expectancies with regard to the product.

### SUMMARY

This Summary is provided to introduce a selection of concepts in a simplified form that are further described below in the Detailed Description. This Summary is not intended to identify key and/or essential features of the claimed subject matter. Also, this Summary is not intended to limit the scope of the claimed subject matter in any manner.

Aspects of the disclosure pertain to contact expectancy and normalization. A product can be normalized based on product complexity. The normalized product can be compared to a database of products having a similar product complexity to determine contact expectancy for the product. When a quantity of contacts is received, the quantity of contacts can be weighted based on the normalization of the product. The weighted quantity can then be compared to other weighted quantities of other products to facilitate an understanding of whether a product has an issue and/or achievement and to facilitate the allocation of resources within an organization.

### BRIEF DESCRIPTION OF THE DRAWINGS

FIG. 1 is an exemplary diagram illustrating various modules of contact expectancy and normalization;

FIG. 2 is an exemplary diagram illustrating aspects of a network for contact expectancy and normalization;

FIG. 3 is an exemplary diagram illustrating aspects of a network for contact expectancy and normalization;

FIG. 4A is an exemplary diagram illustrating a few examples of product complexity categories;

FIG. 4B is an exemplary diagram illustrating a few examples of product complexity categories;

FIG. 4C is an exemplary diagram illustrating a few examples of product complexity categories;

FIG. 5 is an exemplary operational flow diagram illustrating aspects of contact expectancy and normalization;

FIG. 6 is an exemplary operational flow diagram illustrating aspects of contact expectancy and normalization;

FIG. 7 is an exemplary operational flow diagram illustrating aspects of contact expectancy and normalization;

FIG. 8 is an exemplary computing device; and

FIG. 9 is an exemplary mobile computing device.

### DETAILED DESCRIPTION

Aspects of the disclosure are described more fully hereinafter with reference to the accompanying drawings, which form a part hereof, and which show, by way of illustration, example features. The features can, however, be embodied in many different forms and should not be construed as limited to the combinations set forth herein; rather, these combinations are provided so that this disclosure will be thorough and complete, and will fully convey the scope. Among other things, the features of the disclosure can be embodied as methods, instructions and/or devices. Accordingly, the features described herein can take the form of an entirely hardware, an entirely software and/or various combinations of software and hardware aspects. The following detailed description is, therefore, not to be taken in a limiting sense.

As more fully set forth below, business organizations often receive consumer contacts related to the products that they sell. As used herein, the term “product” can include a product and/or a service. The term “consumer” can include a consumer purchaser of a product, a potential consumer of a product and/or a mid-point consumer such as distributor or seller. The term “contact” can be a communication from a consumer to a business organization regarding a product that the business organization sells and/or will sell in the future. A contact can take the form of a complaint and/or a compliment. A complaint can be a communication from the consumer to the business organization that presents a perceived issue with a product. A complement can be a communication from the consumer to the business organization that presents a perceived achievement of the product. In other situations, a contact can be an “inquiry.” An inquiry can be a generally neutral type of contact. For example, an inquiry can be a request for help with a product, a request for stores that carry a product, and/or the like. Ultimately, an inquiry type contact can be categorized as a complement and/or complaint and processed as more fully set forth below. In other situations, an inquiry type contact can be separated from complaint and/or complement type contacts.

Contacts are sometimes measured in quantity of contacts by number of units sold or shipped. The quantity of contacts received for a product is sometimes used by the organization as an indicator as to whether to allocate organization resources to the product. The organization resources may take the form of quality control resources, engineering resources, marketing resources and the like. As an example associated with a food organization that receives complaint type contacts, snack product X can receive 2000 complaints per million units sold and snack product Y can receive 20 complaints per million units sold. Often, in such situations, the food organization would allocate more resources to snack product X because of the perceived issue in snack product X indicated by the ten-fold contact differential between the products. Stated another way, product X may be perceived as needing more resources than product Y because product X has received more complaints. Yet, even though snack product X and snack product Y are both of a snack product “type”, they can very well include different “product complexities”, which would make the complaint comparison misleading. For example, snack product X can include an intricate manufacturing process and require user preparation before consumption. Snack product Y can include a simple manufacturing process and require little user preparation before consumption. Based on the differences in the products, the 2000 complaints received by the organization for snack product X may very well not be a concern for the organization and the 20 complaints received by the organization for snack product Y may be of great concern to the organization. Yet, this realization is often unattainable because organizations have limited tools for determining any meaningful significance associated with consumer complaint quantities. As such, any prediction of a complaint expectancy is typically a subjective guess and resources are often allocated to products receiving the greatest quantity of complaints regardless of whether there is an actual underlying issue with the product as compared to other products of an organization.

Complement type contacts illustrate a generally opposite example as the above for complaint type contacts. As an example associated with a food organization that receives complement type contacts, snack product X can receive 20 complements per million units sold and snack product Y can receive 2000 complements per million units sold. Often, in such situations, the food organization would perceive that snack product Y is the more successful product because snack product Y has a ten-fold complement value as compared to product X. Stated another way, product X may be perceived as needing more resources than product Y because product X has received less complements. Yet, even though snack product X and snack product Y are both of a snack product “type”, they can very well include different “product complexities”, which would make the complement comparison misleading. For example, snack product X can include an intricate manufacturing process and require user preparation before consumption. Snack product Y can include a simple manufacturing process and require little user preparation before consumption. Based on the differences in the products, the 20 complements received by the organization for snack product X may very well indicate a successful product and the 2000 complements received by the organization for snack product Y may very well indicate that snack product Y is not all that successful. Yet, this realization is often unattainable because organizations have limited tools for determining any meaningful significance associated with consumer complement quantities. As such, any prediction of a complement expectancy is typically a subjective guess and resources are often allocated to products receiving less complements regardless of whether there is an actual underlying issue with the product as compared to other products of an organization.

Further to the above, aspects of the disclosure pertain to the normalization of a product based on the product complexities to generate a product complexity score. The product complexity score can be compared to a database of other product complexity scores of other products to determine an expected contact quantity based on actual contact quantities received for other products. As such, an organization can manage its expectancies based on actual contact quantity data of other products in the market having a similar product complexity score. As more fully set forth herein, the comparison of product complexity scores can identify products having a similar type. For example, a similar type may be the comparison of one or more “snack food products.” Yet, equally applicable herein is that the comparison of the product complexity scores may identify products having unrelated types. For example, a snack food product type may be compared to one or more computer processor type products. Such a comparison can be realized because the products can be normalized by complexity and the product complexity score can be the comparator. When a quantity of contacts is received for the product, the quantity can be weighed based on the product complexity score. The weighed quantity can then be compared to other weighed quantities of other products to facilitate a more meaningful comparison of the significances of the contact quantities as they are related to one another. As such, an organization can better manage its allocation of resources between any products sold by the organization.

Furthermore, even though many of the examples described herein relate to a product, contact expectancy and normalization is fully applicable to a service. Similar to the above, service complexities can be utilized to generate a score. The service complexity score can be compared to a database of other service complexity scores of other services to determine an expected contact quantity based on actual contact quantities received for other services. When a quantity of contacts is received for the service, the quantity can be weighed based on the service complexity score. The weighed quantity can then be compared to other weighed quantities of other services to facilitate a more meaningful comparison of the significances of the contact quantities as they are related to one another.

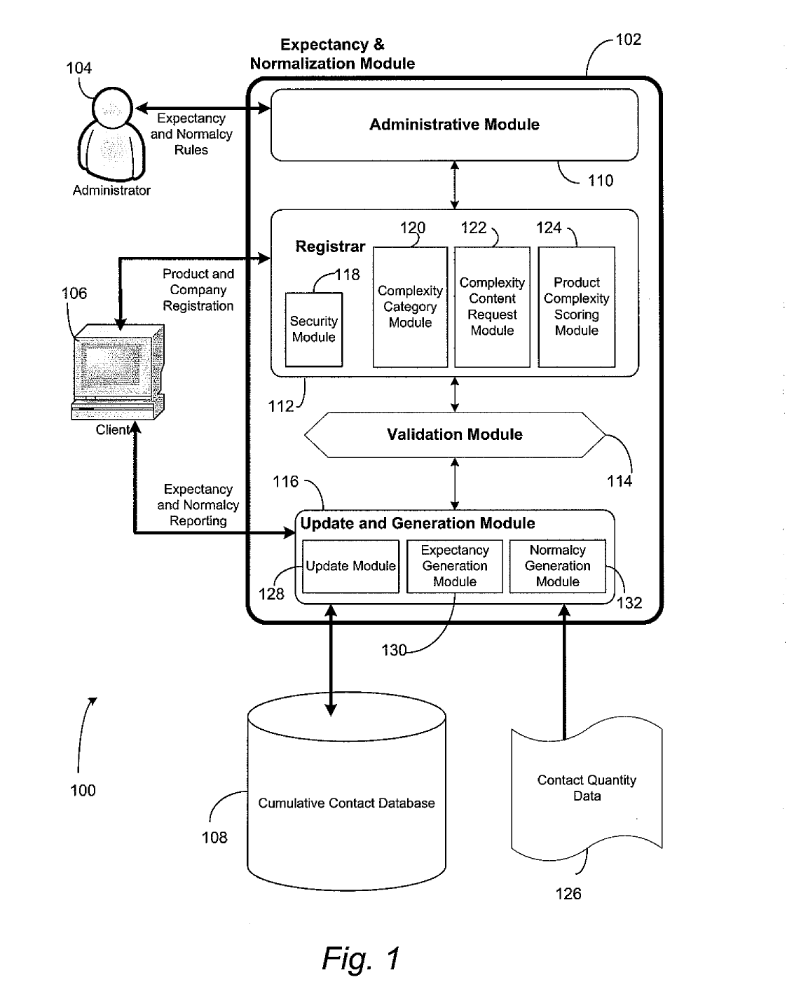

FIG. 1 represents one exemplary system 100 for contact expectancy and normalization. System 100 represents a system overview. System 100 can include various configurations without departing from the functionality set forth in this description. System 100 can be integrated as a combination of software and hardware elements, an operating system or any combination thereof. Hardware, databases, software or applications referenced herein can be integrated as a single module or include various modules in communication with one another. Software and hardware elements are depicted herein for explanatory purposes only and not for limiting the configuration to multiple modules or a single module performing several functions. For example, in FIG. 1, various modules and arrows between modules are depicted for purposes of explaining aspects of functionality and not necessarily for indicating code structure, organization of code, or where code “resides”. It is contemplated that the functionality indicated in FIG. 1 can be located in a myriad of network locations depending on desire, network efficiency, economics, etc. Stated another way, the depiction in FIG. 1 is illustrated as modules to describe the functionality of system 100. The depiction in FIG. 1 of the categorized and named modules is merely for facilitating a logical flow of the description of the functionality of system 100 as set forth herein.

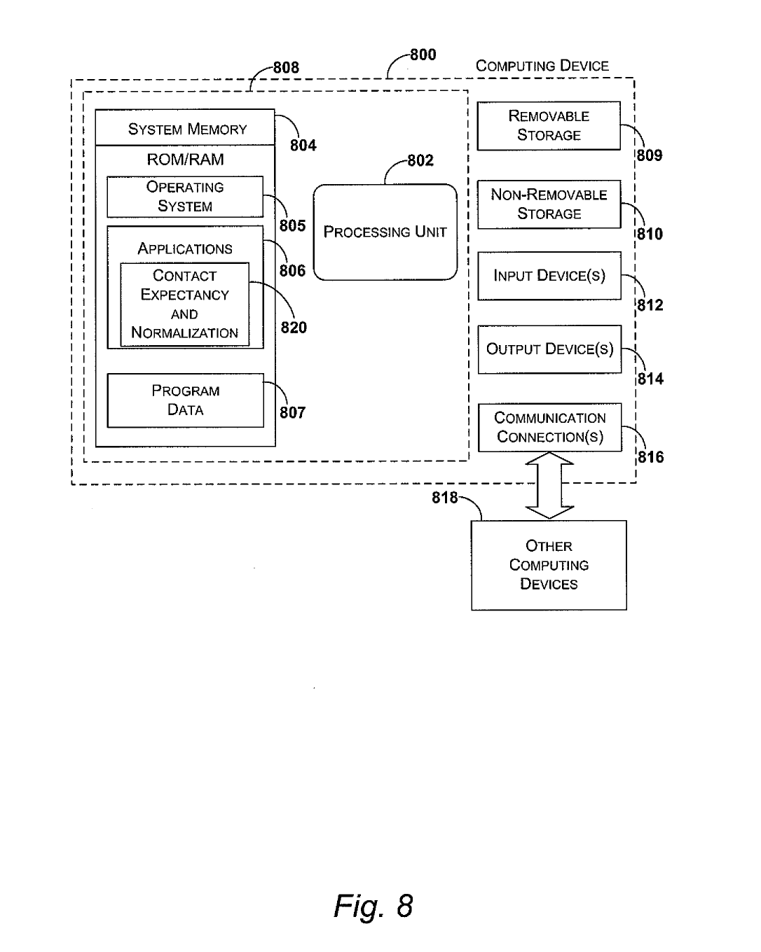

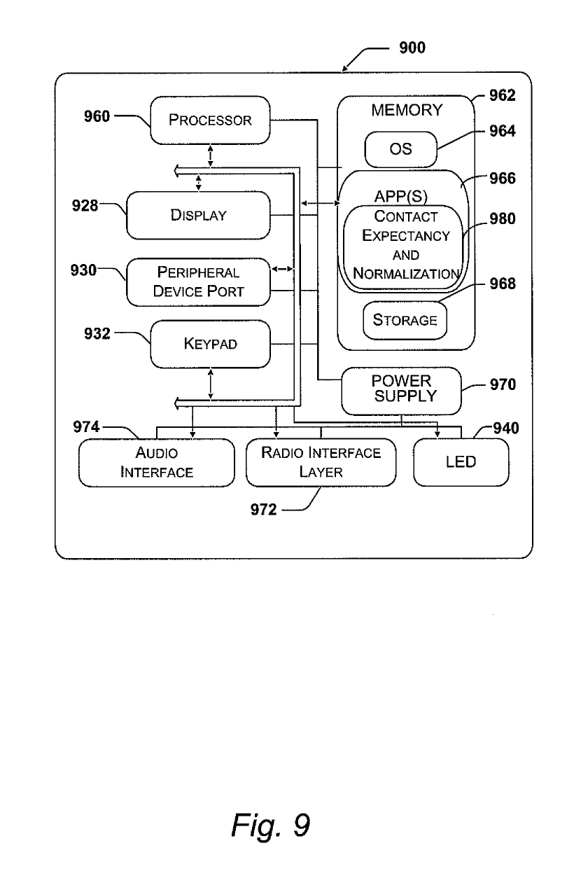

As indicated in FIG. 1, system 100 includes expectancy & normalization module (hereinafter “E&N module”) 102, administrator 104, client 106, and cumulative contact database (hereinafter “database”) 108. Elements 102-108 can include features of computing device 800 as exemplified in FIG. 8 and/or elements 102-108 can include features of mobile computing device 900 as exemplified in FIG. 9.

E&N module 102 can include a server device, a network server device, a desktop computing device, a wireless computing device, a public server device, a third party server device, a localized server device and/or any combination thereof. E&N module 102 can include administrative module 110, registrar 112, validation module 114 and update & generation module (hereinafter “U&G module”) 116. Administrative module 110 can provide communication and functionality for administrator 104. In the situation where system 100 is managed by a single organization, administrator 104 can be an organizational computing device responsible for managing E&N module 102. As another example, system 100 can be managed by a neutral third party organization. In such a situation, administrator 104 can be a neutral third party computing device responsible for managing and moderating E&N module between a myriad of various organizations. Administrator 104 can access E&N module to perform a variety of tasks. For example and as more fully set forth below, administrator 104 can set security and/or accessibility requirements for E&N module 102. Security aspects can include the management of usernames and passwords. Accessibility requirements can include the management of accessibility rules between the myriad of clients and rules associated with the accessibility to private and public data. For example, client A may have access to all of clients A's data; however, client B may have access to a restricted amount of client A's data and/or abstracted access to client A's data. The access and security aspects can also be managed based on requests to administrator 104 from one or more of clients 106 of system 100.

Administrative module 110 can also be responsible for setting and managing one or more groups. For example, administrative module 110 can maintain a “food industry group” with several members and a “computer industry” group with several other members. Each of these groups can be configured by administrative module 110 to include its own group security and group accessibility configurations. Each group and/or subgroup can be further configured with accessibility rights to a portion of the data in cumulative contact database 108.

Administrative module 110 can be configured to execute various other tasks. For example, administrative module 110 can be responsible for receiving change requests from clients via email, text messaging, instant messaging, physical change requests, an application programming interface request, request via a mark-up language document, telephonic or any other electronic form. Such change requests can include requests to change administrative configurations, to change categories in the complexity category module 120, and/or to change the structure of the content request generated by the complexity content request module 122. As another example, administrative module 110 can be configured to generate invoices in association with a client's utilization of E&N module 102. Administrative module 110 can be further configured to receive electronic payments from registered clients. As more fully set forth below, administrative module 110 can be responsible for configuring and maintaining complexity categories associated with complexity category module 120. Also, administrative module 110 can be responsible for configuring the content and structure of a request associated with the complexity content request module 122. In other situations when E&N module 102 is managed by a neutral third party, administrative module 110 can be responsible for validating product entries via validation module 114 as set forth below. In short, administrative module 110 can include various levels of functionality for managing privacy, managing security, managing accounts, managing groups, and/or managing neutrality between a plurality of clients associated with system 100.

As indicated in FIG. 1, E&N module 102 includes registrar 112 for permitting client registration and product registration. Registrar 112 can include security module 118, complexity category module 120, complexity content request module 122, and product complexity scoring module 124. Security module 118 can include functionality for receiving and validating a username and password of client 106. Security module 118 can also include functionality for providing a user name and password to client 106. In one aspect, the security of security module 118 can be managed by administrative module 110. Security module 118 can be further configured to set data accessibility levels for one or more clients 106 and/or groups registered with E&N module 102. For example, client 106 can register a product with E&N module 102. Although client 106 can register the product information under an organizational name, security module 118 can associate a unique identifier with the product information so that data for the product is maintained in association with the unique identifier and so that proprietary product information is restricted to other clients of system 100. In short, security module 118 can include various levels of functionality for providing secured access to system 100, for restricting access to private data and/or for providing access to public data.

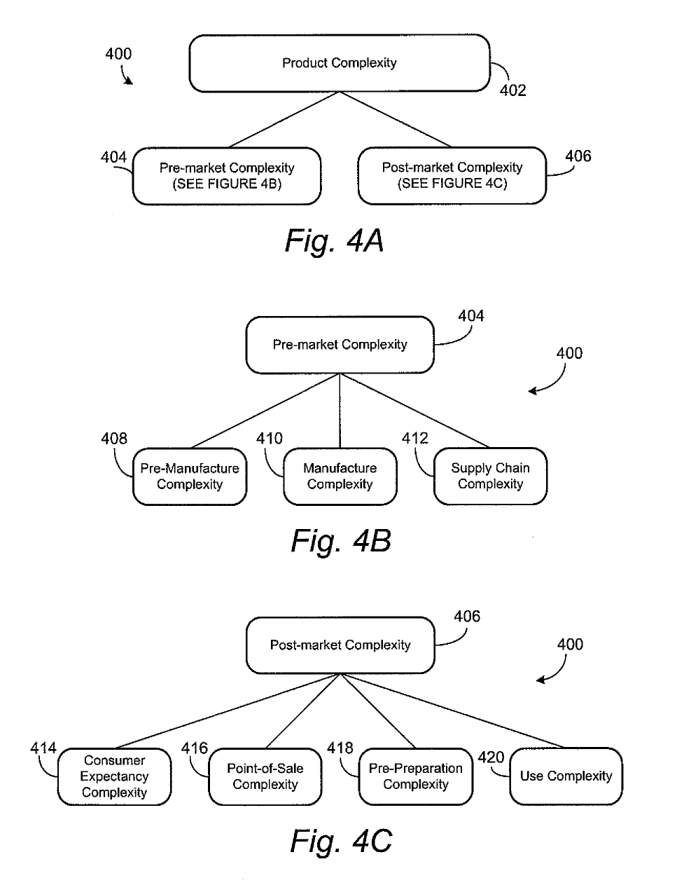

Registrar 112 can further include complexity category module 120. In one aspect, complexity category module 120 can be managed by administrative module 110. The complexity category module can be responsible for generating and/or managing categories of complexity for application to product information being registered with E&N module 102. Examples of categories of complexity are more fully described below in association with FIGS. 4A-4C. In short, examples of the categories can address aspects of how the product is produced, sold and/or utilized. In one aspect, administrative module 110 is responsible for determining initial complexity categories. Once the initial complexity categories are determined, E&N module 102 can include further functionality for allowing registered clients or members of a registered group to vote on the categories and/or suggest modifications to the categories. In other aspects, initial complexity categories can be generated by one or more clients 106. In still other aspects, once the categories are determined, they can be uniformly enforced for registered clients of E&N module 102 and/or for registered members of a group of E&N module. In yet other aspects, enforcement can be based on group membership or organization type. Stated another way, complexity category module 120 can generate multiple sets of complexity categories depending on the group or organization type. As an example, a food industry group can have one set of complexity categories while a software industry group has another set of complexity categories. Again, the grouping of members is but one example of the functionality of E&N module 102. In that products are being normalized by E&N module 102, groups may not be formed and the functionality described herein would still be applicable. In short, complexity category module 120 can moderate and/or maintain complexity categories for E&N module 102.

Registrar 112 further includes complexity content request module 122. After the complexity categories have been determined, request module 122 can be responsible for generating a request to send to client 106 for obtaining values associated with a product complexity of a product being registered. The request can be structured in a multitude of different ways. For example, the request can be a form that client 106 populates. The form can be structured as a mark-up language document such as an eXtensible Mark-up Language document (“XML”) and include guidance or instructions for populating the form. In one example associated with a form, the form can include a table of complexity categories that can be populated by a client with a value within a predetermined range. For example, the table can include a “multiple preparation steps” complexity category. When the product includes several steps that the user is required to perform prior to use of the product, the form can be populated with a high value within the range of values. Similarly, when the product includes few steps that the user is required to perform prior to use of the product, the form can be populated with a low value within the range of values. As another example, the request can be a “question & answer” sequence regarding the product. A client can answer a series of questions. Based on the answers, the questions can be dynamically generated or chosen to drill down to an ultimate value for the complexity category. Other examples of request types include web based requests, physical requests, email requests, text based requests, telephonic requests and/or any other means for obtaining a product complexity value. As stated, request module 122 can generate a request in a multitude of ways and the request can take a multitude of forms. In short, request module 122 can be responsible for obtaining data from client 106 regarding a product being registered in order to score a complexity of a product.

In one aspect, results from the request generated by request module 122 can be received by validation module 114. Validation module 114 can be responsible for confirming the veracity of the information received from client 106. The purpose of validation module 114 is to mitigate any inaccurate information. As more fully set forth herein, one advantage of E&N module 102 stems, in part, from the accuracy of the information that is collected. Accordingly, if inaccurate data regarding a product or product complexities is entered into the system, any expectancies or normalizations generated by E&N module 102 may become skewed. Therefore, a neutral administrator can be given rights to access validation module 114 via administration module 102 to confirm the veracity of data received from client 106. Such verification of the data can be manual. In other situations, E&N module 102 can include a set of rules to verify the data automatically. In still other situations, verification may occur via organizational voting. Validation can occur before or after the complexity data is scored or stored.

Registrar 112 can further include product complexity scoring module 124. As indicated above, registrar 112 can receive one or more values from client 106 associated with the complexity of a product being registered with the system. Based on the values for each complexity of the product, the product can be scored or categorized. For example, the values for each complexity of the product can be totaled to obtain the product complexity score. After scoring of the product based on the complexity values, the product complexity score can be used as set forth below. In other aspects, the product can be further grouped based on the product complexity score. As an example, registrar 112 may be configured to request product complexities for three categories. Each category may receive a maximum value of 5 (product is considered highly complex for the category) and a minimum value of 0 (product is considered very simple for the category). Accordingly, the maximum score can be 15 (complex product) and the minimum score can be 0 (simple product). Registrar 112 can then group the product into, for example, groups A (score 1-3), B (score 4-6), C (score 7-9), D (score 10-12), and E (score 13-15). These groupings can then be further utilized as set forth below. The above product complexity scoring is but a few examples of how a product can be scored based in the product's complexity. Other types of scoring can exist including value scoring, null based scoring, complexity category ranking, scoring by indicators, etc. In short, product complexity scoring module 124 functions to provide some indication in relation to a product for identifying the product's complexity.

After the product is scored, product information and scoring can be stored or updated to cumulative contact database 108 via update module 128. Database 108 can include a relational database, a multidimensional database, and/or any other type of database for organizing and storing data. The database can include product information and product complexity scoring information for a plurality of products from a plurality of organizations. Database 108 can further store contact quantity data 126. Database 108 can be configured with a multitude of fields for a product and/or organization. For example, the database can include a product name field, a product identifier field, an organization name field, an organization identifier field, a product type field, a product complexity score field, an organizational grouping field, a product grouping field, and/or a received contact quantity field. Depending on the features and identification desired for a product, database 108 can further store other information. The above fields of database 108 are but examples.

As indicated above, E&N module 102 includes update & generation module 116. U&G module 116 can include update module 128, expectancy generation module 130 and normalcy generation module 132. After the product has been registered and scored, client 106 can request and/or obtain an expectancy report. Client 106 can send a request to U&G module 116. Expectancy generation module 130 can then query database 108 to generate an expectancy of contacts for the registered product. As indicated above, database 108 can include product complexity scores related to a plurality of products from a plurality of organizations. In one aspect, expectancy generation module 130 queries database 108 with the product complexity score of the registered product to determine other products within database 108 having a similar score. The “similar score” can include matching scores, scores within a range, scores within a threshold, scores within a same group, etc. In other aspects, expectancy generation module 130 can query the database with the registered product complexity score and one or more of: a product type identifier, an organization identifier, an organization group identifier, etc. After matching products are identified based on the similar product complexity scores, contact quantity data can be extracted from database 108 based on the matching and statistically reported to client 106. As an example, the reporting can take the form of an average quantity of expected contacts, a median quantity of expected contacts, a range of expected contact quantities and/or any other type of statistical reporting. The report can further include a statistic contact quantity by, for example, organization type, product type, product complexity, group membership, etc. The report can then be sent or viewed by client 106. The report can be automatically generated in response to an event. The report can be generated in response to a request or action. The report can be periodically generated. The report can be generated based on multidimensional database technologies where client 106 accesses database 108 via an interface. In short, the function of expectancy generation module 130 is to provide contact expectancy for a product based on contact quantity data of other products indicated in database 108.

As stated, U&G module 116 can include normalcy generation module 132. E&N module 102 can receive an indication of an actual contact quantity associated with a registered product. The indication can be received from client 106 and/or received from a consumer. For example, contact quantity data 126 can be received via an input from a registered organization. As another example, contact quantity data 126 can be received on E&N module 102 via a web interface or link to the E&N module. A contact can take the form of a physical contact, an email contact, a text based contact, an electronic contact, a telephonic contact, and/or a statistical abstraction of a quantity of contacts. The contact quantity data can be a value, a value per number of units shipped, a value per number of units sold, a percentage of units shipped, a percentage per units sold, etc. The format of the contact quantity data may be preselected by an administrator, be based on an organization type, be based on an organizational group, be voted on by an organization group, and/or the like.

In one aspect, normalcy generation module 132 obtains contact quantity data 126 for a product. The contact quantity data can be stored in association with a product identifier in database 108. Contact quantity data 126 of the product can be weighed based on the product complexity score of the product. Weighing of contact quantity data 126 can be facilitated in a multitude ways. For example, contact quantity data 126 can be multiplied by the product complexity score, divided by the product complexity score, factored by the product complexity score, and/or any combination of the same. The weighed contact quantity can then be reported to client 106 for comparison to other weighed contact quantities for other products. As previously stated, the reporting can be automatically generated in response to an event. The report can be generated in response to a request or action. The report can be periodically generated. The report can be generated based on multidimensional database technologies where client 106 accesses database 108 via an interface. In short, the function of normalcy generation module 132 is to weigh contact quantity data for a product based on the product complexity score of the product.

As a non-limiting example of system 100 in association with complaint type contacts, organization A registered product A1 with system 100. Likewise, organization B registered product B1 with system 100. Product complexity scoring occurred by system 100 as follows:

Product A1
Product Complexity Category 1: product complexity score equals 2
Product Complexity Category 2: product complexity score equals 2
Product Complexity Category 3: product complexity score equals 1
Total Complexity Score equals 5

Product B1
Product Complexity Category 1: product complexity score equals 2
Product Complexity Category 2: product complexity score equals 1
Product Complexity Category 3: product complexity score equals 2
Total Product Complexity Score equals 5

Products A1 and B1 are stored in cumulative database 108. Product A1 then receives 500 complaints per million units sold. Product B1 receives 600 complaints per million units sold. The quantity of contacts for products A1 and B1 are also stored in database 108. Subsequently, Organization C decides to register product C1 and C2 with system 100. Product complexity scoring occurs by system 100 as follows:

Product C1
Product Complexity Category 1: product complexity score equals 3
Product Complexity Category 2: product complexity score equals 1
Product Complexity Category 3: product complexity score equals 1
Total Product Complexity Score equals 5

Product C2
Product Complexity Category 1: product complexity score equals 4
Product Complexity Category 2: product complexity score equals 4
Product Complexity Category 3: product complexity score equals 2
Total Product Complexity Score equals 10

Organization C then requests expectancy for the quantity of complaints associated with product C1. System 100 determines that products A1 and B1 include similar complexity scores (e.g., 5). Based on the similar complexity scores, expectancy is returned to organization C indicating an expectancy average of 550 complaints and/or a range of 500-600 complaints per million units sold. System 100 then receives an indication that product C1 received 700 complaints per million units sold and product C2 received 1000 complaints per million units sold. In determining quality control resource allocation for organization C, system 100 weighs the complaints by the product complexity score. Thus, the weighed complaint quantity for product C1 is 700/5 or 140 and the weighed complaint quantity for product C2 is 1000/10 or 100. As such, even though product C2 received more complaints than product C1, product C1 has a higher weighed complaint quantity than product C2. From this reporting, organization C can realize that the complaint quantity for product C1 is outside of the expectancy and that more quality control resources should be allocated to product C1 as opposed to C2, even though product C I received less complaints than product C2.

As another non-limiting example of system 100 in association with complement type contacts, organization A registered product A1 with system 100. Likewise, organization B registered product B1 with system 100. Product complexity scoring occurred by system 100 as follows:

Product A1
Product Complexity Category 1: product complexity score equals 2
Product Complexity Category 2: product complexity score equals 2
Product Complexity Category 3: product complexity score equals 1
Total Complexity Score equals 5

Product B1
Product Complexity Category 1: product complexity score equals 2
Product Complexity Category 2: product complexity score equals 1
Product Complexity Category 3: product complexity score equals 2
Total Product Complexity Score equals 5

Products A1 and B1 are stored in cumulative database 108. Product A1 then receives 500 complements per million units sold. Product B1 receives 600 complements per million units sold. The quantity of contacts for products A1 and B1 are also stored in database 108. Subsequently, Organization C decides to register product C1 and C2 with system 100. Product complexity scoring occurs by system 100 as follows:

Product C1
Product Complexity Category 1: product complexity score equals 3
Product Complexity Category 2: product complexity score equals 1
Product Complexity Category 3: product complexity score equals 1
Total Product Complexity Score equals 5

Product C2
Product Complexity Category 1: product complexity score equals 4
Product Complexity Category 2: product complexity score equals 4
Product Complexity Category 3: product complexity score equals 2
Total Product Complexity Score equals 10

Organization C then requests expectancy for the quantity of complaints associated with product C1. System 100 determines that products A1 and B1 include similar complexity scores (e.g., 5). Based on the similar complexity scores, expectancy is returned to organization C indicating an expectancy average of 550 complements and/or a range of 500-600 complements per million units sold. System 100 then receives an indication that product C1 received 1000 complements per million units sold and product C2 received 700 complements per million units sold. In determining quality control resource allocation for organization C, system 100 weighs the complements by the product complexity score. Thus, the weighed complement quantity for product C1 can be 1000×5 or 5000 and the weighed complement quantity for product C2 can be 700×10 or 7000. As such, even though product C1 received more complements than product C2, product C1 has a lower weighed complement quantity than product C2. From this reporting, organization C can realize that the complement quantity for product C1 is outside of the expectancy and that more quality control resources should be allocated to product C1 as opposed to C2, even though product C1 received more complements than product C2.

Again, the above examples are but examples associated with a few aspects of the disclosure. As indicated herein, the above example is not inclusive of all of the features associated with the disclosure.

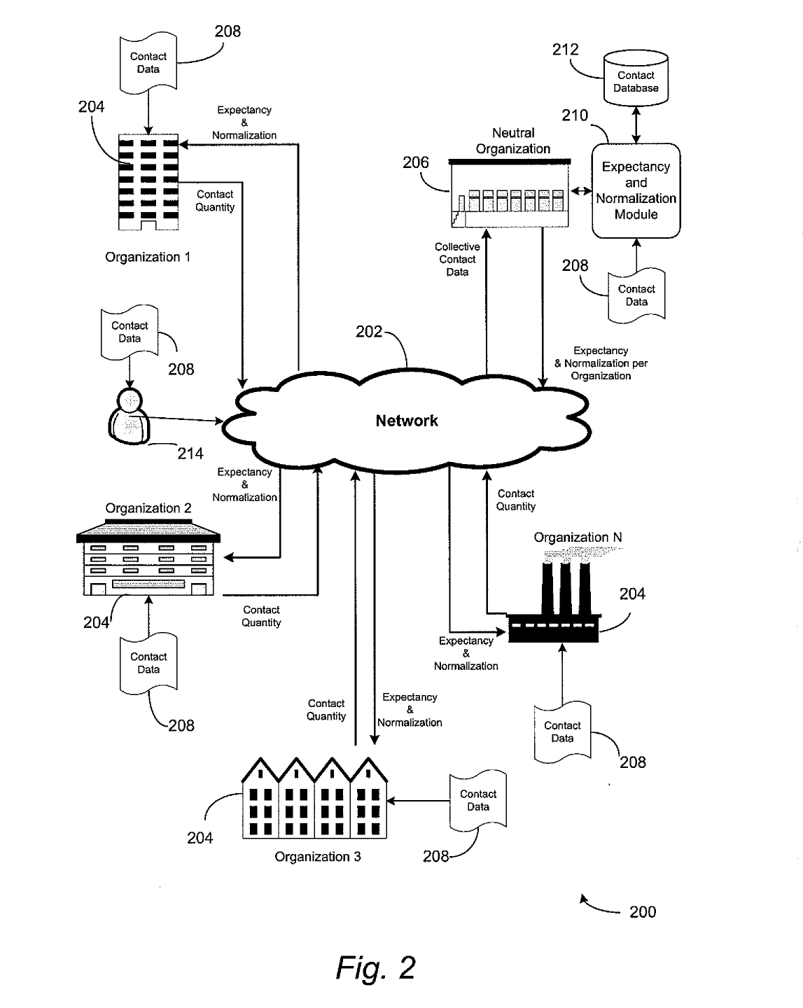

FIG. 2 is an exemplary diagram illustrating aspects of network community 200 for contact expectancy and normalization. Network community 200 can include network 202. As indicated, network 202 can be the Internet, an open network, a closed network, an internal network, a wireless network, a hardwired network, a secured network, a virtual private network, and/or any other type of network that facilitates the transmission of data. Network community 200 can further include one or more organizations 204. Organizations 204 can be part of a same industry. For example, the same industry can include a food industry, a manufacturing industry, a pharmaceutical industry, a computer industry, a software industry, and/or any other type of industry that facilitates goods, products or services. Given the normalization of products described herein, in other aspects of FIG. 2, one or more organizations 204 can be part of different industries.

Network community 200 can further include neutral organization 206. In one aspect, neutral organization 206 can include an independent third party organization that maintains some administrative oversight for E&N module 210 and database 212. In other aspects, neutral organization 206 can also be one or more of organizations 204. E&N module 210 and database 212 can reside at neutral organization 206. In other aspects, E&N module 210 can reside at one or more locations accessible via network 202.

As indicated, contact data is obtained by E&N module 210. The contact data can be obtained in a multitude of ways. For example, contact data 208 can be first received by one or more of organizations 204 before being obtained by E&N module 210. Contact data 208 can be directly obtained by E&N module 210. In another aspect, E&N module 210 can receive contact data via a web interface accessible to consumer 214.

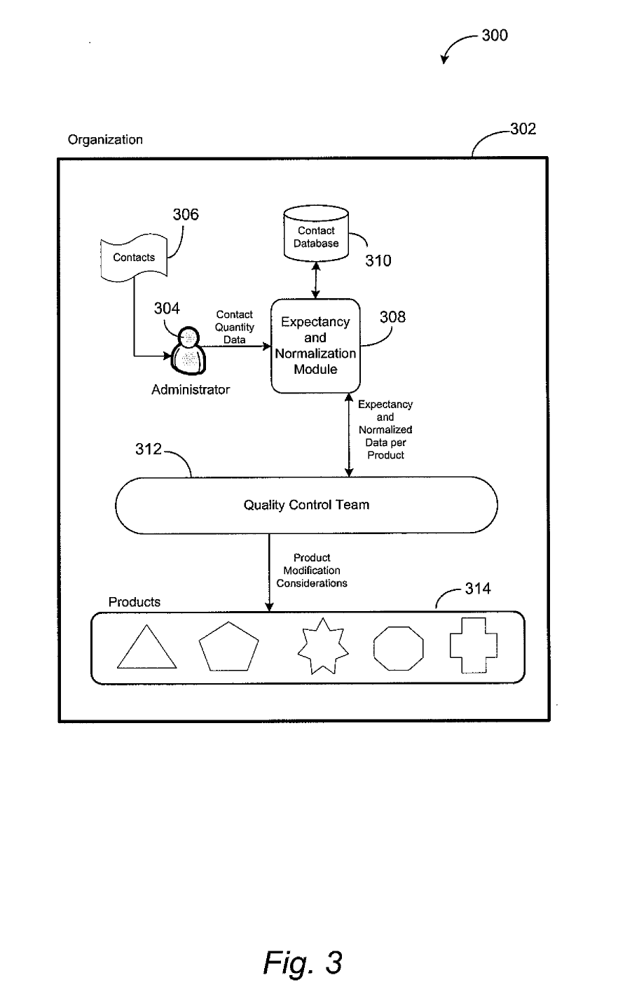

FIG. 3 is an exemplary diagram illustrating aspects of network 300 for contact expectancy and normalization. Network 300 can be associated with an intranet of organization 302. Administrator 304 can be responsible for obtaining and logging contacts 306 to E&N module 308. E&N module 308 can include a module associated with the intranet of organization 302. In other aspects, E&N module 308 can include a plug-in that includes a portion of the functionality of E&N module 308 located on a client device of administrator 304. Quality control team 312 can be allocated communication privileges with E&N module 308 to determine resource allocation for products 314. As used herein, quality control team 312 is broadly defined. The quality control team may include a team associated with the allocation of monetary resources, associated with human resources, associated with equipment resources, associated with scheduling resources, associated with outside organization resources, associated with third party resources, associated with marketing resources, and the like.

FIGS. 4A-4C include complexities 400 for describing herein various types and features of product complexity 402 that can be utilized by administrator 104 to generate product complexity categories. Product complexities can be any category of a product that can be scored to indicate a potential for receiving a consumer contact. In one aspect, a product complexity category can be a category associated with a product that inherently causes consumer contacts based on the nature of the product. Stated another way, the product complexity category can be a category associated with the product that causes consumer contacts even though there is not an immediately available remedy for the product that would address the contact. For example, a contact could indicate an off flavor of a food product. Such a contact could be remedied by changing an ingredient or process. For such an issue, a solution to the contact is available. Yet, as another example, a contact may indicate that choking occurred in association with a cheese cube product. A remedy to such a contact is not necessarily immediately available because the contact stems from the inherent nature of the product or processing of the product.

Complexities 400 in FIGS. 4A-4C are for example and explanation purposes only. Complexities 400 are not meant to limit the term “product complexity” in any manner or imply any inclusiveness of any described complexity into another complexity. The illustrated levels of complexity can be exclusive of one another. Product complexities can be described in a myriad of different ways and can include a myriad of various categories depending on an organizational industry and/or the implicated product. Furthermore, many of the examples herein implicate product complexities associated with a food manufacturer. These examples are not meant to limit the scope of the disclosure herein to a food manufacturer. The disclosure herein is equally applicable to any product manufacturer or service organization regardless of the product or service type.

A complexity category can be associated with, for example, pre-market complexity 404 and/or post-market complexity 406. Pre-market complexities 404 can stem from problem potentials prior to a product being distributed. Post-market complexities 406 can stem from problem potentials after the product is distributed. Pre-market complexity 404 can be associated with, for example, pre-manufacturing complexity 408, manufacturing complexity 410 and/or supply chain complexity 412.

Pre-manufacturing complexities 408 can be associated with, for example, a raw product complexity. As an example, a raw product can be susceptible to foreign material, be susceptible to insects, require inspection, and/or have varying integrity. Pre-manufacturing complexities 408 can also be associated with, for example, a raw product storage complexity. As an example, a raw product can require storage at a temperature to mitigate spoilage. A raw product can also be susceptible to insects or rodents during storage. Pre-manufacturing complexities 408 can further be associated with, for example, a raw product inspection complexity. For example, a raw product can require detailed inspection upon receipt. The more detailed the inspection the higher susceptibility to error. These examples indicate some attributes of pre-manufacturing complexities 408 that are a potential for a product contact. Accordingly, the higher the susceptibility the higher the product complexity for the respective category.

Manufacturing complexity 410 can be associated with, for example, a manufacturing chain complexity. The manufacturing complexity 410 can include, for example, a quality control check complexity. For, example, as a product is being manufactured it can undergo various quality control checks. The more detail required for the check, the higher susceptibility to error. Manufacturing complexity 410 can also be associated with, for example, a manufacturing chain automation complexity. The more complex the automation or machinery, the higher the susceptibility for a product error. Manufacturing complexity 410 can further be associated with, for example, a manufacturing chain manual interaction complexity. The more complex the human interaction required to produce a product, the higher the susceptibility for a human error in the product. Manufacturing complexity 410 can also be associated with, for example, a manufacturing chain rate complexity. The faster products move through a manufacturing chain, the higher the susceptibility for an error in a product. Manufacturing complexity 410 can further be associated with, for example, a multi-component manufacturing complexity. The more components required to make a product, the more potential that a product could be assembled inappropriately. Manufacturing complexity 410 can also be associated with, for example, a packaging complexity. Some packages for products are very simple (e.g., a box) other packages have multiple parts (e.g., cellophane, compartments, etc). The more parts to a package, the higher the susceptibility that the packaging has errors. Manufacturing complexity 410 can further be associated with, for example, a first pass quality complexity. For, example, when a product is manufactured, it can undergo various quality control checks. The more detail required for the check, the higher susceptibility to errors. These examples indicate attributes of manufacturing complexity 410 that are a potential for a contact. Accordingly, the higher the susceptibility the higher the product complexity for the respective category.

Supply chain complexity 412 can be associated with, for example, a product warehousing complexity. As an example, a product can require storage at a temperature to mitigate spoilage. A product can also be susceptible to insects or rodents during storage. Supply chain complexity 412 can also be associated with, for example, a product transportation complexity. For example, product transportation can require temperature controlled transportation, transportation by a certain carrier type, and/or transportation in a certain time frame. Supply chain complexity 412 can further be associated with, for example, a product receiving complexity. For example, product receiving can require temperature controlled receiving, receiving at a particular location, and/or receiving in a certain time frame. These examples indicate attributes of supply chain complexity 412 that are a potential for a product contact. Accordingly, the higher the susceptibility the higher the product complexity for the respective category.

A complexity category can also be associated with, for example, post-market complexity 406. Post-market complexity 406 can be associated with, for example, consumer expectancy complexity 414, point-of-sale complexity 416, pre-preparation complexity 418, and/or use complexity 420.

Consumer expectancy complexity 414 can be associated with, for example, a marketing complexity. A marketing complexity can be indicative of statements made regarding quality during a marketing campaign. The higher the assertion of quality the higher the consumer expectancy. A marketing complexity can also be indicative of capital resources for marketing, marketing audience, and marketing strategy. Consumer expectancy complexity 414 can also be associated with, for example, an intended audience complexity. A target audience can include children or elderly individuals. The young and elderly can have difficulty with particular products (e.g., choking, opening packaging, etc). Consumer expectancy complexity 414 can further be associated with, for example, a price point complexity. In many instances, price point is correlated to quantity of contacts for a product because the higher the cost, the higher the quality a consumer expects. These examples indicate attributes of consumer expectancy complexity 414 that are a potential for a product contact. Accordingly, the higher the susceptibility the higher the product complexity for the respective category

Point-of-sale complexity 416 can be associated with, for example, an inventory turning complexity. Product turning can vary between retailers. Some retailers can turn products regularly to avoid any product spoilage or expiration. Other retailers cannot turn products as quickly. Point-of-sale complexity 416 can also be associated with, for example, a product storage complexity at the point-of-sale. Many products require storage at the point-of-sale to avoid spoilage. The storage required can be at a specific temperature or humidity. These examples indicate attributes of point-of-sale complexity 416 that are a potential for a product contact. Accordingly, the higher the susceptibility the higher the product complexity for the respective category.

Pre-preparation complexity 418 can be associated with, for example, a consumer storage complexity. After being purchased by a consumer, many products require a particular type of storage to avoid spoilage. Pre-preparation complexity 418 can also be associated with, for example, a package complexity. Many products are packaged in glass and/or complex packaging that require interaction by the consumer. These examples indicate attributes of pre-preparation complexity 418 that are a potential for a product contact. Accordingly, the higher the susceptibility the higher the product complexity for the respective category.

Use complexity 420 can be associated with, for example, a pre-use complexity. Many products require preparation prior to use, such as assembly, thawing, mixing, manipulating a package, etc. As an example in the food industry, use complexity 420 can also be associated with, for example, a cooking complexity. Many products require one or more complex steps during the cooking of the product. Use complexity 420 can further be associated with, for example, a post-cooking complexity. Many products require several steps prior to consumption. For example, a product can need to be cooled, mixed, etc. Other products can be resealable and reusable after a first use. These examples indicate attributes of use complexity 420 that are a potential for a product contact. Accordingly, the higher the susceptibility the higher the product complexity for the respective category.

Again, the above examples associated with FIGS. 4A-4C are but a few examples of how product complexities can be identified and categorized. As indicated, as the complexity of a product increases, the potential for a product error increases which can result in a contact. In short, product complexities can be any category of a product that can be scaled to indicate a potential for receiving a consumer contact.

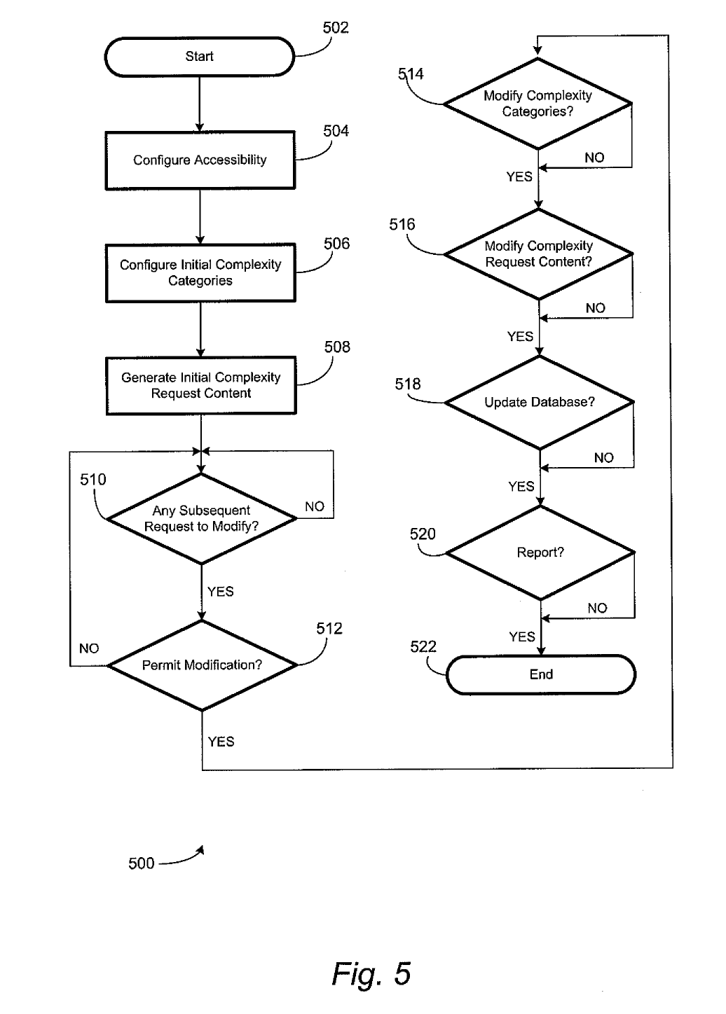

FIGS. 5-8 indicate several exemplary operations associated with functionality described in this disclosure. Even though FIGS. 5-8 indicate start operations and end operations, the operations associated with FIGS. 5-8 should not be read as being mutually exclusive or an ultimate start or ultimate end to overall functionality described herein. Given that in some situations the operations herein are dependent actions, given that aspects of this disclosure include “learning” functionality, and/or given that data is dynamically updatable, operational flow associated with FIGS. 5-8 can flow amongst one another. Stated another way, FIGS. 5-8 illustrate examples of some aspects of functionality related to the overall functionality and should not be interpreted to limit other combinations of functionality made evident by the full breadth of this disclosure.

FIG. 5 is an exemplary operational flow diagram illustrating aspects associated with administration of contact expectancy and normalization. Operational flow 500 begins at start operation 502 and continues to operation 504 where accessibility is configured. Accessibility can be configured by setting username and password policies. Configuration can also be configured by setting policies associated with the accessibility to public and private data based on permissions associated with a registered organization. Accessibility can also be configured by setting encryption policies and programs securing stored and/or the transmission of data. Accessibility can be further configured to set policies and/or rules associated with the formation of groups and/or subgroups of membership.

From operation 504, operation flow 500 continues to operation 506 where complexity categories are configured. In one aspect, complexity categories are initially set by an administrator. In other situations, configuration categories can be proposed by organizations through a suggestion program or a voting program. Complexity categories can be determined as any category associated with a product that has a potential for being the cause of a consumer contact.

Operational flow 500 continues to operation 508, where complexity request content is generated and formatted. The complexity content of the request can be generated from the determined complexity categories associated with operation 506. As set forth herein, the structure of the request can include a form such as a mark-up language form. As another example, the request can be a “question & answer” sequence regarding the product. As previously stated, a request can be generated and formatted in a multitude of ways.

Operation flow 500 continues to decision operation 510, where it is determined whether a request to modify has been received. As indicated in operation 506 and operation 508, initial complexity categories and initial complexity request content are determined, respectively. At decision operation 510, requests to modify the complexity categories and the request can be received. For example, an organization can request that a complexity category is added, modified, changed, removed, etc. As another example, an organization can request that the complexity request content or format is changed, modified, added to, deleted from, etc. In still other aspects, requests can be received regarding modification to the features of the administration configuration. In the situation where a modification request is not received at decision operation 510, operation flow 500 can loop back and wait or further monitor for any requests.

In the situation where a modification request is received at decision operation 510, operational flow 500 continues to decision operation 512, At decision operation 512, it is decided whether to permit the modification or to reject the modification. The decision, at decision operation 512, can be based on an administrative decision, preset rules, voting by registered organizations, voting by registered organizations of a group, voting by registered members of a subgroup, a manual determination, an automatic determination based on a preset configuration, a combination of determinations and/or any other manner for such a determination. In the situation where the requested modification is rejected, operation flow 500 loops back to wait or further monitor for any more requests. In other situations, the rejection of the requested modification can be reported to interested organizations.

In the situation when the modification is permitted, operation flow 500 continues to operation 514, where it is determined whether to modify a complexity category. In the situation where the permitted request includes a permitted request to modify a complexity category, a complexity category can be modified and operation flow 500 continues to decision operation 516. In the situation where the permitted request does not include a permitted request to modify a complexity category, operation flow 500 also continues to decision operation 516.

At decision operation 516 a determination is made as to whether to modify complexity request content. In the situation where the permitted request includes a permitted request to modify the complexity request content, the complexity request content can be modified and operation flow 500 continues to decision operation 518. In the situation where the permitted request does not include a request to modify complexity request content, operation flow 500 also continues to decision operation 518.

At decision operation 518 a determination is made as to whether to update the database. As an example, the database can include entries associated with a multitude of products from a multitude of organizations as more fully set forth herein. A permitted modification associated with decision operation 512 can have an ultimate affect on the rights associated with the database, security associated with the database, groupings associated with the database, encryption associated with the database, the recording of data in the database, and/or the product complexity scoring associated with products associated with the database. As such, the database can need to be updated based on permitted modifications. In situations where the database requires updating, the database can be updated and operational flow 500 continues to decision operation 520. In situations where the database does not require updating, operation flow 500 can also continue to decision operation 520.

At decision operation 520, a determination is made as to whether to report any changes associated with a permitted modification request. If reporting is desired, affected organizations associated with the permitted modification can be sent a report indicating the permitted modification and/or an indication of any affect of the permitted modification to related data stored in the database. If reporting is not desired, operational flow 500 can continue to end operation 522. For example, reporting may not be desired in the situation where an administrative policy is changed that has little or no ultimate affect on data stored in the database.

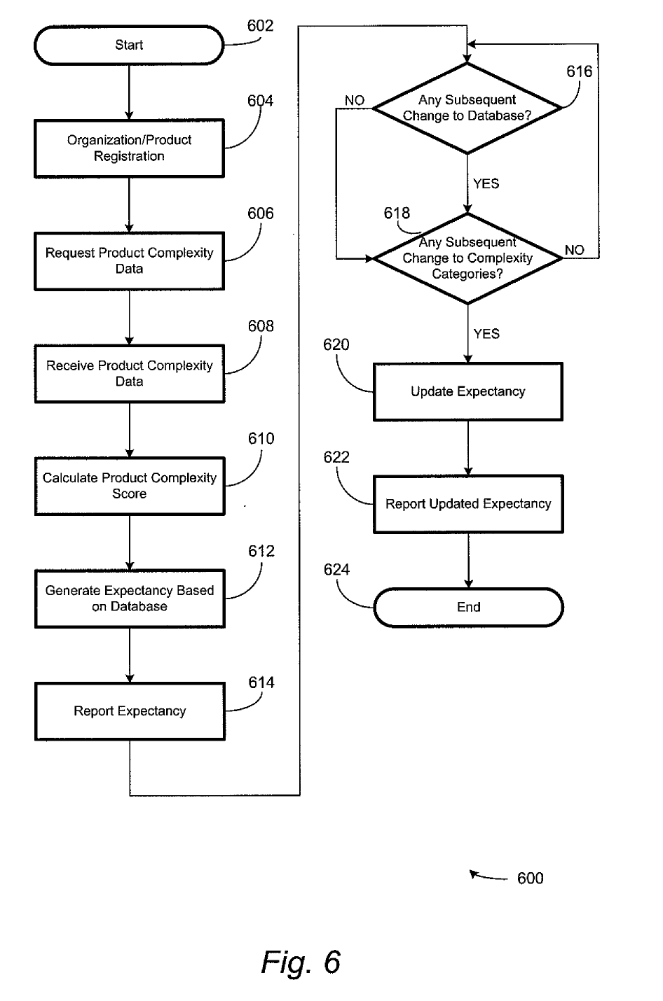

FIG. 6 is an exemplary operational flow diagram illustrating aspects of product registration and expectancy. Operational flow 600 begins at start operation 602 and continues to operation 604 where an organization and/or product are registered. As set forth above, an organization can register as a member to receive expectancy and/or contact normalization data. An organization can also register with a group or subgroup associated with the system. Registration can include the organization registering data related to the organization such as organization name, industry type, address, contact information, accessibility decisions, private and public data choices, product types, product information, etc.

Operational flow 600 can continue to operation 606 where product complexity data is requested. As indicated, the product complexity data can include a plurality of categories and be structure in a variety of forms. At operation 608, the product complexity data is received and at operation 610 the product complexity data is scored. As indicated above, the product complexity data and the product complexity score can be stored in a database in association with a product identifier and an organization identifier.

Operational flow 600 continues to operation 612 where an expectancy is generated. As indicated above, an expectancy can be generated by identifying other products in the database that include a similar product complexity score. Products in the database that include the similar product complexity score can be identified in order to extract actual contact quantities. The quantities can then be utilized to calculate a plurality of statistics associated with the expected contact quantities that are expected for the product.

Operational flow 600 continues to operation 614, where the expectancy is reported to the registered organization. Operational flow 600 continues to decision operation 616. At decision operation 616, it is decided whether any subsequent changes to the database have been received that would require an update to the report generated at operation 614. For example, changes associated with FIG. 5 can cause a subsequent change to the database. In other aspects, updates associated with other products such as received contacts can be a subsequent change to the database that would have an affect on any expectancy associated with operation 614.

In the situation where it is determined that there are not subsequent changes to the database, operation flow 600 continues to decision operation 618. Also, in the situation where it is determined that there are subsequent changes to the database, operational flow 600 continues to decision operation 618. At decision operation 618, it is determined whether there are any subsequent changes to complexity categories that can have an affect on the generated expectancy. If not, operational flow 600 loops back to further wait or monitor for any subsequent changes. If so, operation flow 600 continues to operation 620 where any subsequent changes associated with decision operation 616 and/or decision operation 618 are utilized to update the expectancy associated with the expectancy generated at operation 612.

Operational flow 600 continues to operation 622 where the updated expectancy is reported. In one aspect, the updated expectancy can be reported in a manner similar to operation 614. Operational flow 600 then continues to end operation 624.

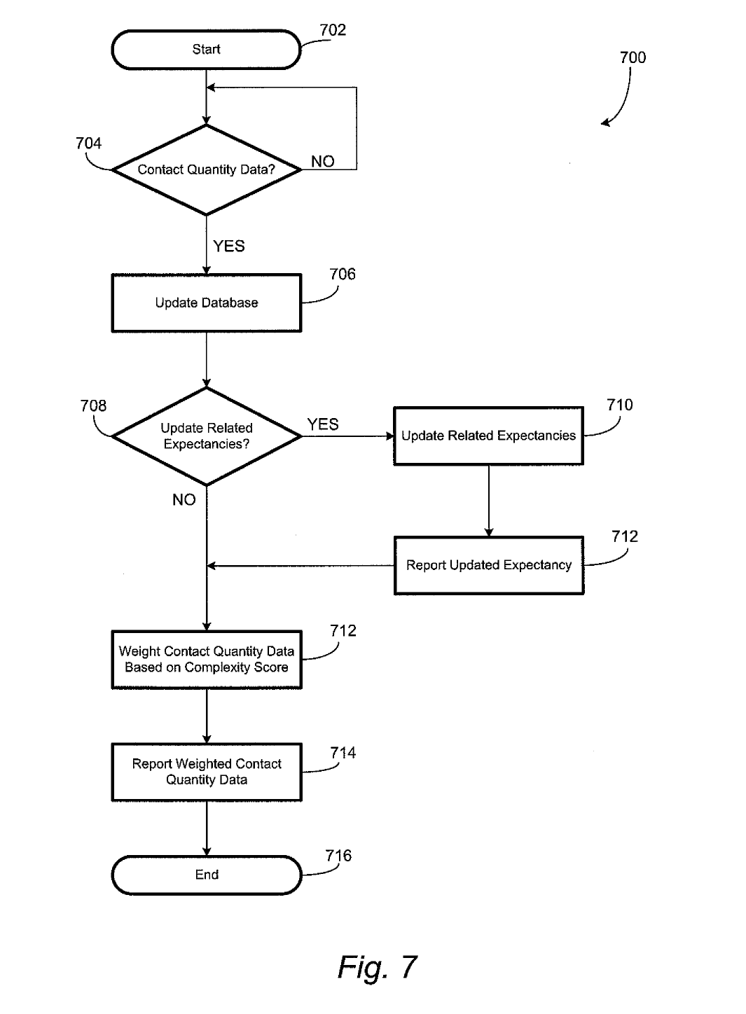

FIG. 7 is an exemplary operational flow diagram illustrating aspects associated with the weighing of product contact quantities. Operational flow 700 begins at start operation 702 and continues to decision operation 704 where it is determined whether a quantity of contacts has been obtained. If not, operational flow 700 loops back and further waits or monitors for an indication of received contact quantity data. If so, operational flow 700 continues to operation 706 where the database is updated with the quantity of contacts. As stated, the quantity can be associated with a particular product identifier associated with the contact quantity.

Operational flow 700 continues to decision operation 708. At decision operation 708, it is decided whether any related expectancies need to be updated. As previously explained, the actual contact quantity for a product can have an affect on any expectancies associated with the product and/or any expectancies of products in the database having a similar score. In situations where expectancies require updating, decision operation 708 continues to operation 710 where expectancies are updated. Operational flow 700 continues to operation 712 were the updated expectancies are reported as indicated above. Operational flow 700 then continues to operation 714. Also, in the situation were expectancies are not updated, operational flow 700 continues to operation 712.

At operation 712, the received contact quantity data is weighed based on the complexity score of the product. Operational flow 700 continues to operation 714 where the weighed contact quantity data is reported. Operational flow 700 then continues to end operation 716.

Referring to FIG. 8, an exemplary system includes a computing device, such as computing device 800. In a basic configuration, computing device 800 typically includes at least one processing unit 802 and system memory 804. Depending on the exact configuration and type of computing device, system memory 804 can be volatile (such as RAM), non-volatile (such as ROM, flash memory, and the like) or some combination of the two. System memory 804 typically includes operating system 805, one or more applications 806, and can include program data 807. In one aspect, applications 806 further include application 820 for contact expectancy and normalization. In another aspect, operating system 805 includes contact expectancy and normalization features. This basic configuration is illustrated in FIG. 8 by those components within dashed line 808.

Computing device 800 can also have additional features or functionality. For example, computing device 800 can also include additional data storage devices (removable and/or non-removable) such as, for example, magnetic disks, optical disks, or tape. Such additional storage is illustrated in FIG. 8 by computer readable storage medium 809 and non-removable storage 810. Computer readable storage medium can include volatile and non-volatile, removable and non-removable media implemented by, for example, stored computer readable instructions, stored data structures, stored program modules or other stored data. System memory 804, computer readable storage medium 809 and non-removable storage 810 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other tangible medium which can be used to store the desired information and which can be accessed by computing device 800. Any such computer storage media can be part of device 800. Computing device 800 can also have input device(s) 812 such as a keyboard, mouse, pen, voice input device, touch input device, etc. Output device(s) 814 such as a display, speakers, printer, etc., can also be included. All these devices are known in the art and need not be discussed at length here.

Computing device 800 also contains communication connection(s) 816 that allow the device to communicate with other computing devices 818, such as over a network or a wireless network. Communication connection(s) 816 is an example of communication media. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

FIG. 9 illustrates a mobile computing device that can be used in one exemplary aspect of the disclosure. With reference to FIG. 9, one exemplary system includes a mobile computing device, such as mobile computing device 900. The mobile computing device 900 has processor 960, memory 962, display 928, and keypad 932. Memory 962 generally includes both volatile memory (e.g., RAM) and non-volatile memory (e.g., ROM, Flash Memory, or the like). Mobile computing device 900 includes operating system 964, which is resident in memory 962 and executes on processor 960. Keypad 932 can be a push button numeric dialing pad (such as on a typical telephone), or a multi-key keyboard (such as a conventional keyboard). Display 928 can be a liquid crystal display, or any other type of display commonly used in mobile computing devices. Display 928 can be touch-sensitive, and would then also act as an input device.

One or more application programs 966 are loaded into memory 962 and run on operating system 964. Mobile computing device 900 also includes non-volatile storage 968 within memory 962. Non-volatile storage 968 can be used to store persistent information which is not lost if mobile computing device 900 is powered down. Applications 966 can use and store information in storage 968. In one aspect, applications 966 further include application 980 for contact expectancy and normalization. In another embodiment, operating system 964 includes contact expectancy and normalization.

Mobile computing device 900 has power supply 970, which can be implemented as one or more batteries. Power supply 970 might further include an external power source, such as an AC adapter, or a powered docking cradle that supplements or recharges the batteries.

Mobile computing device 900 is shown with two types of external notification mechanisms: LED 940 and audio interface 974. These devices can be directly coupled to power supply 970 so that when activated, they remain on for a duration dictated by the notification mechanism even though processor 960 and other components might shut down to conserve battery power. LED 940 can be programmed to remain on indefinitely until the user takes action to indicate the powered-on status of the device. Audio interface 974 is used to provide audible signals to and receive audible signals from the user.

Mobile computing device 900 also includes radio interface layer 972 that performs the function of transmitting and receiving communications, such as radio frequency communications. Radio interface layer 972 facilitates wireless connectivity between mobile computing device 900 and the outside world, via a communications carrier or service provider. Transmissions to and from radio interface layer 972 are conducted under control of operating system 964. In other words, communications received by radio interface layer 972 can be disseminated to application programs 966 via operating system 964, and vice versa.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

We claim:

1. A computer-readable storage medium having computer executable instructions for normalizing a product based on a product complexity score to facilitate reporting of contact quantity information, the instructions comprising:
obtaining product complexity data for a product;
determining a product complexity score based on the obtained product complexity data for the product;
matching the product complexity score to a product complexity score of at least one other product;
obtaining consumer contact quantity data of the at least one other product based on the matching;
based on the obtained consumer contact quantity data of the at least one other product, calculating a product contact quantity expectancy; and
reporting an indication of the product contact quantity expectancy.

2. The computer-readable storage medium of claim 1, wherein the obtained product complexity data is based on a calculated value associated with at least one preconfigured product complexity category.

3. The computer-readable storage medium of claim 2, wherein the at least one preconfigured product complexity category includes at least one member of a group comprising:
a pre-market complexity category associated with the calculated value, and a post-market complexity category associated with the calculated value.

4. The computer-readable storage medium of claim 2, wherein the at least one preconfigured product complexity category includes at least one member of a group comprising: a pre-manufacture complexity category associated with the calculated value, a manufacture complexity category associated with the calculated value, and a supply chain complexity category associated with the calculated value.

5. The computer-readable storage medium of claim 2, wherein the at least one preconfigured product complexity category includes at least one member of a group comprising: a consumer expectancy complexity category associated with the calculated value, a point-of-sale complexity category associated with the calculated value, a pre-preparation complexity category associated with the calculated value, and a use complexity category associated with the calculated value.

6. The computer-readable storage medium of claim 1, wherein the product is a service.

7. The computer-readable storage medium of claim 1, wherein obtaining product complexity data for a product includes at least one member of a group comprising: obtaining product complexity data from a form, and obtaining product complexity data from a question & answer sequence.

8. The computer-readable storage medium of claim 1, wherein determining a product complexity score based on the obtained product complexity data for the product includes at least one member of a group comprising: group scoring, value scoring, null based scoring, complexity category ranking, and indicator scoring.

9. The computer-readable storage medium of claim 1, wherein matching the product complexity score to a product complexity score of at least one other product includes matching at least one member of a group comprising: a value associated with the product complexity score to a value of the product complexity score of the at least one other product, a range of values determined from the product complexity score to a value of the product complexity score of the at least one other product, a threshold determined from the product complexity score to a value of the product complexity score of the at least one other product that is within the threshold, and a grouping indicator determined from the product complexity score to a grouping indicator of the product complexity score of the at least one other product.

10. The computer-readable storage medium of claim 1, wherein the product contact expectancy includes at least one member of a group comprising: an expected average quantity of contacts, an expected median quantity of contacts, and an expected range of contact quantities.

11. The computer-readable storage medium of claim 1, further comprising:
obtaining an indication of a received quantity of consumer contacts for the product;
weighing the received quantity of consumer contacts by the determined product complexity score to generate a weighed quantity of consumer contacts for the product; and
reporting an indication of the weighted quantity of consumer contacts for the product.

12. The computer-readable storage medium of claim 11, wherein the indication of the received quantity of consumer contacts for the product is at least one member of a group comprising: a value of consumer contacts, a value of consumer contacts per number of units shipped, a value of consumer contacts per number of units sold, a percentage of consumer contacts per number of units shipped, and a percentage of consumer contacts per number of units sold.

13. A computer-implemented method for normalizing a product based on a product complexity score to facilitate reporting of contact quantity information, the method comprising:
obtaining product complexity data for a product;
determining a product complexity score based on the obtained product complexity data for the product;
matching the product complexity score to a product complexity score of at least one other product;
obtaining consumer contact quantity data of the at least one other product based on the matching;
based on the obtained consumer contact quantity data of the at least one other product causing a processor to calculate a product contact quantity expectancy; and
reporting an indication of the product contact quantity expectancy.

14. The computer-implemented method of claim 13, wherein the obtained product complexity data is based on a calculated value associated with at least one preconfigured product complexity category.

15. The computer-implemented method of claim 14, wherein the at least one preconfigured product complexity category includes at least one member of a group comprising: a pre-market complexity category associated with the calculated value, and a post-market complexity category associated with the calculated value.

16. The computer-implemented method of claim 13, wherein the product includes a service.

17. The computer-implemented method of claim 13, wherein matching the product complexity score to a product complexity score of at least one other product includes matching at least one member of a group comprising: a value associated with the product complexity score to a value of the product complexity score of the at least one other product, a range of values determined from the product complexity score to a value of the product complexity score of the at least one other product, a threshold determined from the product complexity score to a value of the product complexity score of the at least one other product that is within the threshold, and a grouping indicator determined from the product complexity score to a grouping indicator of the product complexity score of the at least one other product.

18. The computer-implemented method of claim 13, wherein the product contact expectancy includes at least one member of a group comprising: an expected average quantity of contacts, an expected median quantity of contacts, and an expected range of contact quantities.

19. The computer-implemented method of claim 13, further comprising:
obtaining an indication of a received quantity of consumer contacts for the product;
causing the processor to weigh the received quantity of consumer contacts by the determined product complexity score to generate a weighed quantity of consumer contacts for the product; and
reporting an indication of the weighted quantity of consumer contacts for the product.

20. The computer-implemented method of claim 19, wherein the received quantity of consumer contacts for the product is at least one member of a group comprising: a value of consumer contacts, a value of consumer contacts per number of units shipped, a value of consumer contacts per number of units sold, a percentage of consumer contacts per number of units shipped, and a percentage of consumer contacts per number of units sold.

21. A system for normalizing a product based on a product complexity score to facilitate reporting of contact quantity information, the system comprising:
at least one processor;
at least one memory;
a registrar, stored on the at least one memory, configured to cause the at least one processor to obtain product complexity data for a product, and determine a product complexity score based on the obtained product complexity data for the product; and
an expectancy module, stored on the at least one memory, configured to cause the at least one processor to match the product complexity score to a product complexity score of at least one other product, obtain consumer contact quantity data of the at least one other product based on the matching, and calculate a product contact quantity expectancy based on the obtained consumer contact quantity data of the at least one other product.

22. The system of claim 21, further comprising an administrative module, wherein the administrative module is stored on the at least one memory and is configured to cause the at least one processor to manage accessibility to the registrar.

23. The system of claim 22, wherein the administrative module is further configured to cause the at least one processor to manage product complexity categories.

24. The system of claim 21, further comprising a validation module, wherein the validation module is stored on the at least one memory and is configured to cause the at least one processor to validate the obtained product complexity data.

25. The system of claim 21, further comprising a normalcy module, wherein the normalcy module is stored on the at least one memory and is configured to obtain an indication of a received quantity of consumer contacts for the product, and weigh the obtained quantity of consumer contacts by the determined product complexity score to generate a weighed quantity of consumer contacts for the product.

26. A computer-readable storage medium having computer executable instructions for normalizing a product based on a product complexity score to facilitate reporting of contact quantity information, the instructions comprising:
obtaining product complexity data for a product;
determining a product complexity score based on the obtained product complexity data for the product;
obtaining an indication of a received quantity of consumer contacts for the product;
weighing the indication of the received quantity of consumer contacts by the determined product complexity score to generate a weighed quantity of consumer contacts for the product; and
reporting an indication of the weighted quantity of consumer contacts for the product.

27. The computer-readable storage medium of claim 26, wherein the obtained product complexity data is based on a calculated value associated with at least one preconfigured product complexity category.

28. The computer-readable storage medium of claim 27, wherein the at least one preconfigured product complexity category includes at least one member of a group comprising: a pre-market complexity category associated with the calculated value, and a post-market complexity category associated with the calculated value.

29. The computer-readable storage medium of claim 27, wherein the at least one preconfigured product complexity category includes at least one member of a group comprising: a pre-market complexity category associated with the calculated value, and a post-market complexity category associated with the calculated value.

30. The computer-readable storage medium of claim 27, wherein the at least one product complexity category includes at least one member of a group comprising: a pre-manufacture complexity category associated with the calculated value, a manufacture complexity category associated with the calculated value, and a supply chain complexity category associated with the calculated value.

31. The computer-readable storage medium of claim 26, wherein the product includes a service.

32. The computer-readable storage medium of claim 26, wherein obtaining product complexity data for a product includes at least one member of a group comprising: obtaining product complexity data from a form, and obtaining product complexity data from a question & answer sequence.

33. The computer-readable storage medium of claim 26, wherein determining a product complexity score based on the obtained product complexity data for the product includes at least one member of a group comprising: group scoring, value scoring, null based scoring, complexity category ranking and indicator scoring.

34. A computer-implemented method for normalizing a product based on a product complexity score to facilitate reporting of contact quantity information, the method comprising:
obtaining product complexity data for a product;
determining a product complexity score based on the obtained product complexity data for the product;
obtaining an indication of a received quantity of consumer contacts for the product;
causing the processor to weigh the indication of the received quantity of consumer contacts by the determined product complexity score to generate a weighed quantity of consumer contacts for the product; and
reporting an indication of the weighted quantity of consumer contacts for the product.

35. The computer-implemented method of claim 34, wherein the obtained product complexity data is based on a calculated value associated with at least one preconfigured product complexity category.

36. The computer-implemented method of claim 35, wherein the at least one preconfigured product complexity category includes at least one member of a group comprising: a pre-market complexity category associated with the calculated value, and a post-market complexity category associated with the calculated value.

37. The computer-implemented method of claim 34, wherein determining a product complexity score based on the obtained product complexity data for the product includes at least one member of a group comprising: group scoring, value scoring, null based scoring, complexity category ranking and indicator scoring.

38. A system for normalizing a product based on a product complexity score to facilitate reporting of contact quantity information, the system comprising:
at least one processor;
at least one memory;
a registrar, stored on the at least one memory, configured to cause the at least one processor to obtain product complexity data for a product, and determine a product complexity score based on the obtained product complexity data for the product; and
a normalcy module, stored on the at least one memory, configured to obtain an indication of a received quantity of consumer contacts for the product, and weigh the obtained quantity of consumer contacts by the determined product complexity score to generate a weighed quantity of consumer contacts for the product.

39. The system of claim 38, further comprising an administrative module, wherein the administrative module is stored on the at least one memory and is configured to cause the at least one processor to manage accessibility to the registrar.

40. The system of claim 39, wherein the administrative module is further configured to cause the at least one processor to manage product complexity categories.
